(19) United States
(12) Patent Application Publication
(10) Pub. No.: US 2010/0061500 A1
(43) Pub. Date: Mar. 11, 2010

(54) COMPACT NEUTRON SOURCE AND MODERATOR

(75) Inventors: Tak Pui Lou, Berkeley, CA (US); Jani Reijonen, Princeton, NJ (US); Melvin Arthur Piestrup, Woodside, CA (US)

Correspondence Address: FULBRIGHT AND JAWORSKI LLP, 555 S. FLOWER STREET, 41ST FLOOR, LOS ANGELES, CA, 90071, US

(73) Assignee: The Regents of the University of California, Oakland, CA (US)

(21) Appl. No.: 12/303,851

(22) PCT Filed: Jun. 11, 2007
(86) PCT No.: PCT/US07/13638

§ 371 Date: Nov. 23, 2009

Related U.S. Application Data
(60) Provisional application No. 60/812,114, filed on Jun. 9, 2006.

(51) Int. Cl. G21B 1/00

(52) U.S. Cl. 376/114

(57) ABSTRACT

A novel method and compact neutron source for generating thermal neutrons is described that uses an ion source to emit ions toward a target where neutrons are generated. Surrounding the target is a secondary electron shield, and surrounding the target is a first stage moderator to reduce the energy of generated fast neutrons. Enclosing the first stage moderator is a second stage moderator with a thermal neutron port.

### RELATED APPLICATIONS

This application claims priority from Provisional Patent Application Ser. No. 60/812,114 filed Jun. 9, 2006, and this application incorporates by reference all subject matter contained in that provisional patent application.

### STATEMENT REGARDING FEDERALLY SPONSORED RESEARCH OR DEVELOPMENT

This invention was made with government support under Contract No. DE-AC02-05CH 11231 awarded by the United States Department of Energy to The Regents of the University of California for management and operation of the Lawrence Berkeley National Laboratory. The government has certain rights in this invention.

### BACKGROUND OF THE INVENTION

1. Field of the Invention

This invention relates generally to small neutron sources and more specifically to bright thermal neutron beam production from compact sources including neutron energy moderators.

2. Description of the Related Art

Non-Destructive Testing (NDT) of structures through imaging of internal structural parts is a known examination procedure and is continuing to be further developed in ever expanding business arenas. Imaging of internal parts or portions of structures using x-rays and y-rays is a multibillion dollar business. Not yet well developed, though, is NDT imaging using neutrons, i.e., neutron radiography.

This situation arises because practical, small and relatively portable thermal neutron sources that provide bright or intense beams of thermal neutrons have not been available. Bright or intense neutron beams have a large number of neutrons per second passing through a defined area, i.e., n/sec-cm². To date, neutron radiography primarily has been done in laboratories using thermal neutrons, i.e., about 0.025 electron-volt (eV) energy neutrons, provided from nuclear reactors. Clearly, nuclear reactors are complex, and both extremely costly and large. Use of nuclear reactors as thermal neutron sources limits industrial applications. These laboratory experiments, however, have demonstrated the potential industrial utility of neutron radiography, but implementation of practical industrial applications has been restricted by the unavailability of small, portable sources of bright, thermal neutron beams.

Currently available portable neutron sources include isotope material sources, that use neutron producing radio isotopes such as Californium (Cf 252). These radio isotope sources fail as practical thermal neutron sources for neutron radiography because of their low neutron output and in particular because they produce neutrons in all directions that preclude outputting bright narrow neutron beams. Further, radio isotope sources raise safety issues and logistical complications. For example, concerns have increased recently about the physical security of radio isotope sources because of their possible use in dirty bombs.

Also currently available as neutron sources are systems using ion beams to produce deuterium (D)-tritium (T), D-D or T-T reactions. Neutrons produced by such reactions, however, have energies that must be attenuated in order to be at thermal energy levels. To slow produced neutrons down to thermal energies requires passage of the neutrons through a moderator material. Known moderator material arrangements involve arrangement of moderator material about a primary neutron source where the D-D, D-T or T-T reactions occur and produce fast neutrons in all directions. Accordingly such primary neutron source and moderator arrangements are quite large in size. Since the reaction produced fast neutrons are emitted in all directions, the large exterior surface of the area of the arranged moderator material determines the minimal source size. Many neutron radiography applications require high brightness thermal neutron sources, and when oversized sources with their low brightness emitted neutron beams are used the resulting radiography images have intrinsically lowered resolution.

Currently known neutron radiography applications among many others that could use small bright thermal neutron sources include: NDT at nuclear power plants; NDT for aircraft inspection; and, boron neutron capture cancer therapy.

To assure safe operation of nuclear power plants, the rates of corrosion at critical locations must be monitored along with the integrity of critical system components such as reactor coolant pump seals. Neutron radiography could be used to provide such monitoring if effective portable bright neutron sources were available, and, thereby, greatly reduce maintenance costs and unscheduled downtime. Other inspections that neutron radiography could be used for include: detection and characterization of material fractures and crack growth; and, examinations of inaccessible and otherwise unobservable structures such as metallic pressure boundaries. Neutron radiography not only could provide significant operation and maintenance cost savings, but also could improve structural integrity assessments and estimates of critical machinery and component remaining lifetimes. Thereby, providing for more accurate planning for nuclear reactor maintenance outages and in-service inspections.

Commercial, military and private aircraft are being used for increasingly longer lifetimes, and thus require more accurate and involved inspections. Neutron radiography is ideal, for example, in detecting and monitoring corrosion of aircraft structural components. Neutron radiography also is ideal for inspecting structures such as piping and conduits enclosed in multiple layers of extended insulation materials. Other inspection techniques for these situations such as ultrasonic inspections are ineffective or impossible to apply. Information on the state and location of corrosion can be precisely provided using neutron radiography, whereas the same detail of information would not be available using x-ray inspection. Canadian studies have shown that neutron radiography is the only inspection method that can detect small areas of moisture entrapment and corrosion (W. J Lewis, L. G. I. Bennett, “Moisture and Corrosion Inspection of Aircraft Composite Flight Controls with Neutron Radiography,” 1998 ASNT Spring Conference, Anaheim, Calif.). Neutron computer tomography already is a leading technology used to detect excessive hydration levels that cause titanium jet engine fan blade embrittlement. Neutron radiography also has been used to provide real time imaging of fluid movements in running engines and hydraulic systems to detect voids and other problems.

A non-imaging neutron application where a portable, small bright thermal neutron source could be of significant potential is in the field of medicine. Specifically, such an application is Boron Neutron Capture Therapy (BNCT). Possible applications for BNCT include treatment of brain and liver cancer, and arthritis. The BNCT procedures involve injecting boron-containing compounds into a patient that then accumulate in malignant tumors. A beam of thermal neutrons is directed at the patient to irradiate the malignant tumors where boron atoms preferentially capture neutrons. After capturing neutrons, the excited boron nuclei decay to release short-range radiation (alpha particles). This short-range radiation destroys nearby tumor tissue, but does not travel far enough to damage non-tumor surrounding tissue. To date, nuclear reactors and accelerators, which are large and expensive and are inappropriate for clinical settings, have been used to provide thermal neutrons for BNCT experiments and procedures. The lack of small, convenient, bright, thermal neutron sources has been a major obstacle to acceptance and use of BNCT.

Another non-imaging neutron application where a compact thermal neutron source could be of significant potential is in the field of material analysis, which has to date been generally relegated to large national laboratories due to the historical dependence for the analysis upon nuclear reactors. These techniques, e.g., Prompt Gamma Neutron Activation Analysis (PGNAA). Short-Lived Neutron Activation Analysis (SLNAA), and Neutron Activation Analysis (NAA), could be developed for field use and small laboratory use, if a compact thermal neutron generator could be manufactured, thus severing the ‘umbilical cord’ to nuclear reactors. Combining a PGNAA/SLNAA detection system with a compact thermal-neutron generator has the potential to revolutionize both qualitative and quantitative assays of most inorganic chemicals and certain hetero-organic compounds. All elements from hydrogen up to the highest-Z actinide can be assayed simultaneously with high specificity, quality and, in many cases, sensitivity using neutrons.

The non-destructive nature of PGNAA, SLNAA and NAA, and the penetrating qualities of neutrons offer a unique approach toward the study, for example, of manufacturing-induced metallurgical anomalies in structural materials, chemical anomalies in semiconductor materials, and geological phenomena. There would also be direct applications for portable bright neutron sources to many applications such as Homeland Security issues for the detection of nerve agents and explosives. Also, applications would include the chemical and semiconductor industries, in-field metallurgical evaluations, the characterization of legacy and/or hazardous materials, forensics, the analysis of archaeological artifacts, geological analysis, the detection of land mines, etc. The relative novelty of a portable bright neutron source offers many options to educational institutes that have a strong interest and background in many of the above-cited fields. Internationally, a portable bright neutron source will permit countries to have capabilities to detect and interdict the unauthorized movement of explosives, nerve agents, nuclear, other radioactive materials and also other hazardous materials.

### SUMMARY OF THE INVENTION

Prior encountered problems where intense thermal neutron beams could be used are overcome using a compact ion source with a target where reactions occur to produce fast neutrons that are lowered in energy to thermal neutron levels using moderator materials. Two or more stages of moderator materials can be used for the described thermal neutron source.

The first stage of moderator material is positioned as close as possible to the target. It can be positioned either: (1) about a secondary electron shield that is located close to the target where fast neutrons are produced; or, (2) under a target for both cooling the target and moderating generated fast neutrons. This first stage moderator can be: (1) a layer of water contained in a target shroud having the secondary electron shield as the inner wall; or, (2) a layer of water directly below the target.

The second stage of moderator is positioned about the first stage moderator. The second stage moderator can be made of polyethylene or lead-loaded polyethylene.

A thermal neutron port is positioned through the second stage moderator to provide for a produced thermal neutron ion exit. This thermal neutron port can be cone shaped with a large base of the cone positioned to face the first stage moderator and a small cone apex positioned to output thermal neutrons.

A further advantage of the disclosed compact thermal neutron source is that alternative to outputting thermal neutrons, the disclosed neutron source also can output fast neutrons along a source longitudinal axis.

### BRIEF DESCRIPTION OF THE DRAWINGS

FIG. 1 is a cross-sectional view of a thermal neutron generator that includes an ion source with a target to generate neutrons, the target is shown surrounded by two stages of neutron moderators;

FIG. 2 is an expanded cross-sectional view of the thermal neutron generator shown in FIG. 1 wherein a deuterium ion is shown impacting the target and produced neutrons are shown being emitted from the target and passing through a first stage neutron moderator and also passing into a second stage neutron moderator, with a neutron shown being emitted from the neutron generator and passing through a thermal neutron port;

FIG. 3 is a model diagram for the neutron generator shown in FIGS. 1 and 2 that is used with a Monte Carlo N-Particle (MCNP) model to calculate performance characteristics for configurations of neutron Beam Shaping Assemblies (BSA);

FIG. 4 is a graph showing calculated neutron flux versus neutron energies calculated using the MCNP model for the diagrammed neutron generator shown in FIG. 3;

FIG. 5 is a cross-sectional view of a thermal neutron generator that uses a water coolant chamber under a conical shaped target to moderate generated fast neutrons and cool the target; and,

FIG. 6 is a cross-sectional view of a system for identifying a sample using neutrons provided from a thermal neutron generator of the type shown in FIG. 5.

### DETAILED DESCRIPTION OF THE INVENTION

Aspects of the present invention are described herein in the context of a compact neutron generator including two-stages of neutron moderators to produce a bright thermal neutron beam. Those of ordinary skill in the art will realize that the following detailed description of the present invention is illustrative only and is not intended to be in any way limiting. Other aspects of the present invention will readily suggest themselves to such skilled persons having the benefit of this disclosure. Reference will now be made in detail to implementations of the present invention illustrated in the accompanying drawings. The same reference indicators will be used throughout the drawings and the following detailed description to refer to the same or like parts.

In the interest of clarity, not all of the routine features of the implementations described herein are shown and described. It will, of course, be appreciated that in the development of any such actual implementation, numerous implementation—specific decisions must be made in order to achieve the developer's specific goals, such as compliance with application—and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

The new compact thermal neutron source, designated with the general numeral 10, consists of a Radio Frequency (RF) antenna 12 to power an ion source 14 that emits ions toward a target 16 from which neutrons are emitted because of reactions between incoming ions and ions that previously impacted the target 16. The previously impacted ions are loaded onto the target 16. Types of ions that can be used for these reactions include deuterium-²H (D) or tritium-³H (T). Deuterium-deuterium (D-D) reactions and deuterium-tritium reactions both produce neutrons. The produced neutrons, however, are characterized as fast neutrons because of their about 2.5 to about 14.1 million electron-Volt (MeV) energies. These fast neutrons, after production, must somehow be moderated to thermal energy levels of about 0.025 eV in order for the produced neutrons to be thermal neutrons. Tritium-tritium (T-T) reactions also produce fast neutrons, but T-T reactions are not favored for many applications because of the required amounts of tritium which introduce serious radiation safety requirements.

The ion source 14 emits an intense beam of ions (about 10 milliampers (mA)) at accelerated speeds (about 100 kilvolts (kV)) toward the target 16 that can be a metal hydride material. A useful exterior target 16 coating material for having impacting deuterium or tritium ions loaded so they can be impacted by other deuterium or tritium ions to react is titanium (Ti). Other useful target coating materials or target materials for effecting neutron producing reactions also are known to those skilled in the art. As discussed above the resulting fast neutrons are produced in all directions, i.e., 4 π steradians (str).

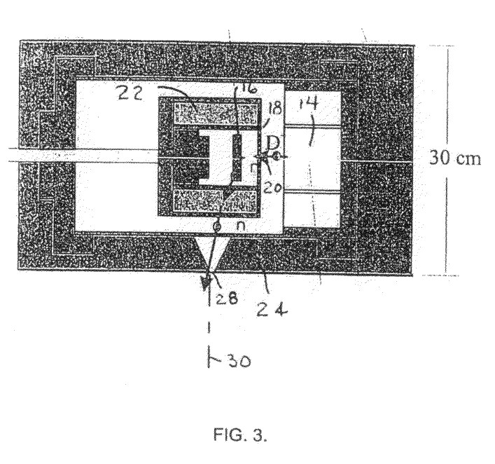

Positioned between the ion source 14 and the target 16 is a secondary electron shield 18 with an ion entrance aperture 20 (see FIG. 3). Ions emitted from ion source 14 are directed to pass through ion entrance aperture 20 and impact target 16. Whereas secondary electrons produced at target 16 or in the vicinity of target 16 are prevented by secondary electron shield 18 from back-streaming toward and damaging ion source 14. To best accomplish such shielding of secondary electron back-streaming by capture of generated secondary electrons, it is useful to have the secondary electron shield 18 positioned adjacent to the point of being as proximate as practical to target 16.

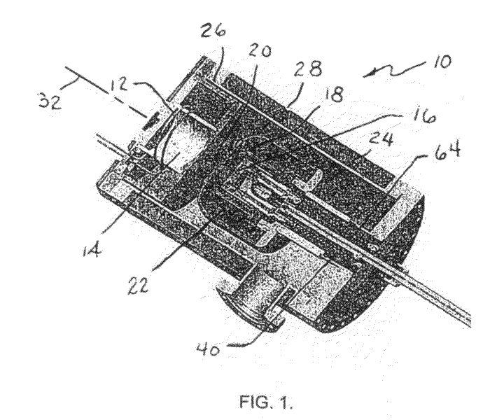

To moderate produced fast neutrons to thermal energies, the compact thermal neutron source 10 includes a first stage moderator 22 and a second stage moderator 24. First stage moderator 22 is positioned as proximate to target 16 where fast neutrons are produced as practical, and second stage moderator 24 is positioned as an exterior component of the compact thermal neutron source 10 as shown in FIG. 1. First stage moderator 22 is accomplished by using secondary electron shield 18 as a surface for a water-filled shroud. The water provides the neutron energy moderating material. As those skilled in the art know, other moderating materials can be used in place of water. Both the proximate and surrounding positioning of the first stage moderator 22 to the target 16 provides for moderation of fast neutrons to thermal energy levels from a small sized neutron source.

Accordingly, in an aspect for the invention, first stage moderator 22 is positioned inside vacuum envelope 26 of compact thermal neutron source 10.

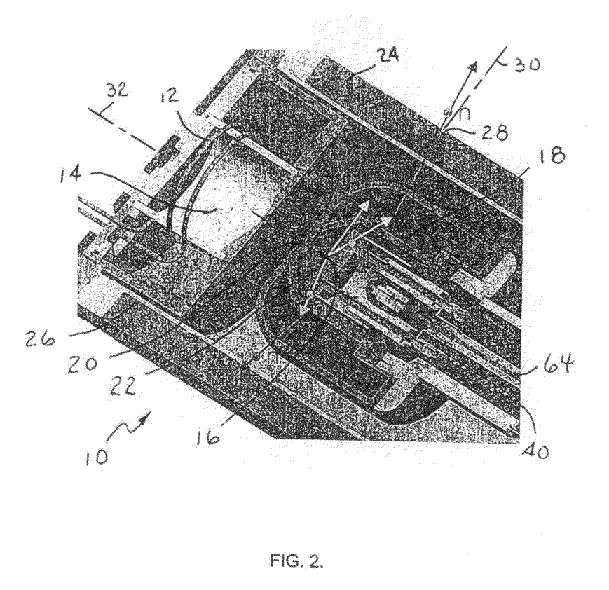

An exit from compact thermal neutron source 10 for produced thermal neutrons is thermal neutron port 28. Assuring that enhanced thermal neutron fluxes are passed out through thermal neutron port 28 requires that first stage moderator 22 be arranged to substantially surround and be proximate to target 16. This arrangement and positioning of first stage moderator 22 ensures that essentially all produced fast neutrons pass through first stage moderator 22 and thereby have their energies reduced inside of vacuum envelope 26. Neutrons further can be slowed down and trapped near the vicinity of the first stage moderator 22 by surrounding the first stage moderator 22 with an additional neutron-absorbing material as a second stage moderator 24. Positioned through second stage moderator 24 is thermal neutron port 28. This thermal neutron port 28 is arranged in a cone shape with a large cone base being directed to be proximate to first stage moderator 22 as opposed to other smaller portions of the cone. This arrangement allows for more neutrons to enter the thermal neutron port 28 cone base from the interior of compact thermal neutron source 10 than would enter, for example, a cylindrical shaped thermal neutron port, and, thereby, more neutrons exit thermal neutron port 28 at the cone apex. To reduce risk of passing fast neutrons through thermal neutron port 28, the central axis 30 of thermal neutron port 28 (see FIG. 2) is aligned to not pass through that portion of target 16 where reactions producing neutrons occur. For a preferred aspect of the invention, this displacement between thermal neutron port central axis 30 and the locations where neutron producing reactions occur is about a few centimeters (cm). Thermal neutron port 28 is lined with about a millimeter thick cadmium (Cd) coating, which is a neutron absorbing material.

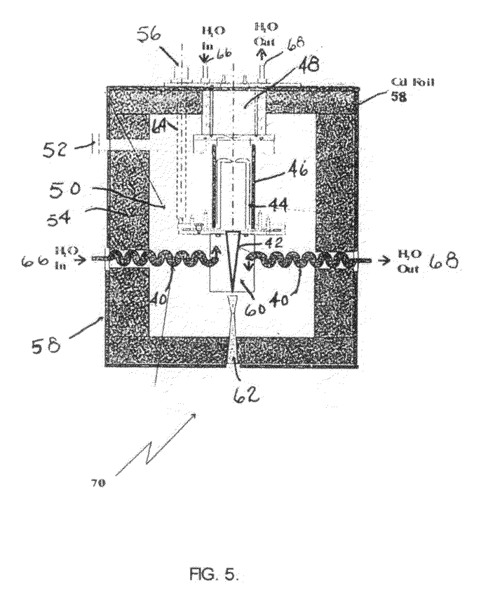

Polyethylene can be a material used for second stage moderator 24. This material moderates fast neutrons and also reflects thermal neutrons. Other neutron energy moderator and reflector materials that could be used for second stage moderator 24 are known to those skilled in the art, and can be so used for second stage moderator 24. For a preferred aspect of the invention, second stage moderator 24 is about 10-40 cm thick. Such an arrangement and sizing of second stage moderator 24 allows cylindrically symmetric side and backscattered neutrons to be directed toward thermal neutron port 28. This sizing and arrangement with respect to target 16 also maximizes elastic and inelastic neutron interactions to increase the potential for forward scattering of thermal energy neutrons toward thermal neutron port 28. A third stage of moderation that surrounds the second stage of moderation can be included to reflect neutrons back into the first and second stages of moderation (e.g., see FIG. 5 and discussion below directed to foil 58).

Various configurations of compact thermal neutron source 10 for neutron beam shaping have been modeled in order to optimize thermal neutron beam outputs. This modeling was effected using a known Monte Carlo N-Particles (MCNP) computerized model. MCNP is a general-purpose software code used for neutron, photon, electron or coupled neutron/photon/electron transport analysis. The MCNP software code uses geometric cells to analyze arbitrary three-dimensional configurations of materials. For neutrons, all reactions given in a particular cross-section evaluation are accounted for using MCNP. Scattering of neutrons is described using a free gas model and tabulated thermal neutron scattering data, S (alpha, beta) treatment are available for some materials such as light water and beryllium.

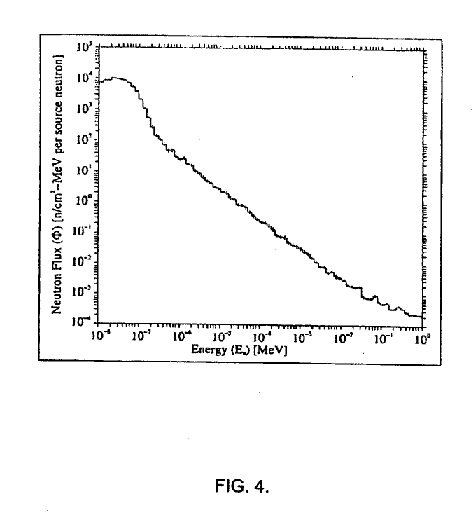

MCNP permits a two plane, two dimensional, graphical input for a modeled compact thermal neutron source 10, including moderator/reflector geometries and materials. In the instance of one modeled embodiment, the compact thermal neutron source 10 had D-D reactions occurring within a 3 cm thick water first stage moderator 22 and a 5 cm thick lead (Pb) loaded polyethylene second stage moderator 24. This modeled arrangement is shown in FIG. 3. the modeled compact thermal neutron source 10 was assumed to be generating fast 2.5 MeV neutrons at a Ti target 16. These generated 2.5 MeV neutrons are designated “source neutrons”, and subsequent resulting neutron fluxes are designated as a function of their energy and as being “per source neutron.” The calculated thermal neutron flux at the exterior surface of first stage moderator 22 is 7.5×10⁴ neutrons (n) per square centimeter (cm²) (n/cm²) per source neutron. Shown in FIG. 4 for this embodiment is a plot of the MCNP calculated neutron flux as a function of neutron energy. Output thermal neutron flux at 10 cm outside second stage moderator 24 was calculated to be 2×10⁻⁷ n/cm² per source neutrons. Epithermal neutron flux (i.e., neutrons having energies less than 0.5 eV but greater than 0.3 eV) at the position was calculated to be 4×10⁻⁵ n/cm² per source neutron. The calculated fast neutron flux (i.e., neutrons having energies greater than 0.5 MeV) was calculated to be about 8×10⁻⁵ n/cm² per source neutron.

The compact thermal neutron source 10 also is capable of being arranged to supply both fast and thermal neutrons. Supply of fast neutrons is along the compact thermal neutron source 10 longitudinal axis 32 where first stage moderator 22 material is minimal. As discussed above, thermal neutron output from compact thermal neutron source 10 is perpendicular to longitudinal axis 32. Fast neutron output along longitudinal axis 32 can effectively occur through ion source 14, because ion source 14 is hollow and only slightly attenuates passing fast neutrons. A fast neutron collinator that consists of separated plates of fast neutron shielding materials (not shown) to collinate a fast neutron beam can be positioned outside of compact thermal neutron source 10. For the above described compact thermal neutron source 10, the produced fast neutron beam can be 1-3 millimeters (mm). The fast neutron intensity will be approximately 10⁹ neutrons per second, and the fast neutron brightness will be on the order of 4×10⁷ n/(sec-mm²-str).

Target 16 can be cooled using recirculated water. To facilitate flexibility and utility in the operation of compact thermal neutron source 10, the water supply for the first stage moderator 22 is provided as an independent supply from the water supply for cooling target 16.

These two water supplies, therefore, can be independently operated. This independence in water supplies provides for operator control of thermal neutron outputs. Specifically, if water is drained from first stage moderator 22, the output of thermal neutrons is minimized.

In another aspect, designated by the general numeral 70, and shown in FIG. 5, a conical target 42 is positioned in a coolant and moderator chamber 60 that functions to both cool the target 42 and moderate the fast neutrons being produced. The coolant and moderator chamber 60 act as the first stage of moderation. In the aspect shown in FIG. 5 two more stages of moderation are used. Polyethylene material 50 is the second stage and this material surrounds the first stage 60. Polyethylene combined with boron 54 is the third stage and this material surrounds the second stage 50. Cadmium (Cd) foil neutron reflector 58 surrounds the entire apparatus to both reflect thermal neutrons and prevent thermal neutrons from escaping. A conical collimator or thermal neutron port 62 is made of Cd foil and provides a path through which thermal neutrons can exit. Those skilled in the art know that other materials can be used for the coolant and moderators.

As in the case of the compact thermal neutron source 10 of FIG. 1, the source 70 of FIG. 5, has an RF induction ion source 48 to produce ions, e.g., deuterium ions, that are accelerated to a titanium coated conical target 42. Other produced ions and ion conical targets 42 can be used. As in the case of source 10, a shroud 44 is used to prevent back streaming of electrons produced by the input ion beam. For source 70 of FIG. 5, a high voltage connection to the conical target 42 is not wrapped around the high voltage cable 64, as is the case for source 10 of FIG. 1. This prevents possible voltage breakdown since the high voltage cable is no longer in direct contact with a water line. In the case of source 70 a ceramic cylinder 46 maintains both vacuum and voltage separation between the RF induction ion source 48 and the conical target 42 and shroud 44. A high voltage connector 56 introduces power to the target 42 via high voltage cable 64.

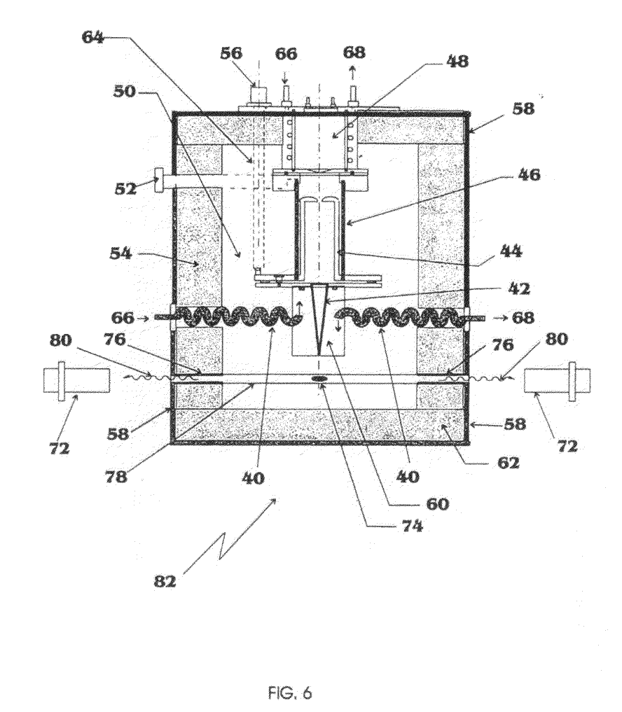

In another aspect for the invention, a compact thermal neutron source and sample system that are designated by the general numeral 82 is shown in FIG. 6. The source apparatus of FIG. 5 is shown in FIG. 6 as modified to be used for activating a sample 74 with neutrons so that sample 74 radiates characteristic gamma-rays 80 that can be analyzed to identify the sample 74. In this case the thermal neutron port 62 in FIG. 5 is eliminated and a sample 74 is positioned inside the moderator 50 via a cylindrical tube 78 as shown in FIG. 6. The sample 74 is placed so that is receives a maximum thermal neutron flux at its position in moderator 50, which can be composed of polyethylene. Characteristic produced gamma-rays 80 are detected and identified by gamma ray detectors 72, which can be high purity Germanium (HPGe) detectors. This analysis method for identifying materials is known as Prompt Gamma Neutron Activation Analysis (PGNAA). Those skilled in this art will appreciate that the moderator materials composed of polyethylene 50, heavy or light water 60, and polyethylene and boron 54 and the thermal neutron shield composed of Cadmium (Cd) foil 58 have to be designed in thicknesses to maximize the thermal neutron flux at the sample 74 while minimizing fast neutrons that could be directed to gamma-ray detectors 72. Fast neutrons can decrease or destroy detection sensitivity of the gamma-ray detectors 72. The thickness of the heavy or light water coolant for moderator 60 can be a minimum of 2 to 4 cm for providing thermal neutrons from fast neutrons of 2.5 MeV energy. To minimize the fast neutron flux that makes it to the gamma-ray detector 72 the thickness of the polyethylene 50 can be 20-50 cm. The cylindrical tube 78 is transparent to thermal neutrons in the polyethylene 50 that could reach gamma-ray detectors 72. This cylindrical tube 78 is made of lead and includes cadmium tubing 76 to collimate the produced gamma-rays 80. The cadmium tubing 76 minimizes the thermal neutron and gamma-rays being generated in the polyethylene.

Those skilled in the art of Short-Lived Neutron Activation Analysis (SLNAA) and Neutron Activation Analysis (NAA) understand that the apparatus shown in FIG. 6 can also be used to identify materials using SLNAA or NAA. In these two cases the unidentified sample is removed from the moderator after it has been activated by thermal neutrons. In the case of the SLNAA, the sample is removed quickly (less than 1 sec) and transported to a position away from the apparatus 82 where there is minimal radiation from other sources, and its gamma-ray emission is analyzed by a gamma-ray detector in order to identify the sample 74. The sample 74 can be removed quickly by means of a pneumatic powered tube. In the case of NAA, the sample 74 can be radiated with thermal neutrons for long periods of time so that its activation is high enough for it to emit gamma-rays at a sufficient rate for the sample 74 to be identified after being removed from the system 82. Activation of the sample 74 need not be done inside the system 82, the activation can be accomplished outside system 82 using an external port for directing thermal neutrons to reach the sample 74. Thus, source 70 as shown in FIG. 5 can be used in this case for activating sample 74.

While embodiments and applications of this invention have been shown and described, it would be apparent to those skilled in the art having the benefit of this disclosure that many more modifications than mentioned above are possible without departing from the inventive concepts herein. The invention, therefore, is not to be restricted except in the spirit of the appended claims.

What is claimed is:

1. A neutron source comprising:
an ion source:
a target;
a secondary election shield disposed about said target, said secondary electron shield including an ion entrance aperture disposed to have ions emitted from said ion source impact said target;
a first stage moderator disposed adjacent said secondary electron shield; and,
a second stage moderator disposed about said first stage moderator.

2. The neutron source according to claim 1 further comprising a plurality of more than one moderator stage disposed about said first stage moderator.

3. The neutron source according to claim 1 with said first stage moderator disposed below said target with said ion source disposed above said target.

4. The neutron source according to claim 1 further comprising a thermal neutron port disposed through said second stage moderator.

5. The neutron source according to claim 4 further comprising a thermal neutron port central axis disposed not to pass through said target where neutrons are generated.

6. The neutron source according to claim 4 further comprising a neutron absorbing material disposed about an exterior surface of said thermal neutron port.

7. The neutron source according to claim 1 further comprising a titanium coating disposed on said target.

8. The neutron source according to claim 1 wherein said first stage moderator includes a layer of water.

9. The neutron source according to claim 1 wherein said second stage moderator includes a layer of polyethylene.

10. The neutron source according to claim 1 wherein said second stage moderator includes a layer of lead loaded polyethylene.

11. The neutron source according to claim 8 wherein said first stage moderator layer of water is at least 3 centimeters thick between said target and a thermal neutron port disposed through a second stage moderator.

12. The neutron source according to claim 10 wherein said second stage moderator layer of lead loaded polyethylene is at least 5 centimeters thick between a first stage moderator disposed about said target and an exterior surface of said second stage moderator.

13. The neutron source according to claim 8 wherein the water is heavy water.

14. A method of production of neutrons comprising:
directing ions emitted from an ion source to impact a target where neutrons are produced;
capturing secondary electrons at a secondary electron shield disposed about said target;
passing generated neutrons through a first stage moderator disposed about said secondary electron shield or target to provide first moderated neutrons; and
passing the first moderated neutrons thorough a second stage moderator disposed about said first stage moderator.

15. The method according to claim 14 further comprising passing the first moderated neutrons through a thermal neutron port disposed through said second stage moderator.

16. The method according to claim 15 wherein a thermal neutron port central axis is disposed not to pass through said target where neutrons are generated.

17. The method according to claim 15 wherein a neutron absorbing material is coated about an exterior surface of said thermal neutron port.

18. The method according to claim 14 wherein a titanium layer is coated on said target where ions from said ion source impact said target

19. The method according to claim 15 wherein said first stage moderator includes a layer of water.

20. The method according to claim 14 wherein said second stage moderator includes a layer of polyethylene.

21. The method according to claim 14 wherein said second stage moderator includes a layer of lead loaded polyethylene.

22. The method according to claim 17 wherein said first stage moderator layer of water is at least 3 centimeter thick between said target and said thermal neutron port.

23. The method according to claim 21 wherein said second stage moderator layer of lead loaded polyethylene is at least 5 centimeters thick between said first stage moderator and an exterior surface of said second stage moderator.

24. The neutron source of claim 1, further comprising:
a tube disposed within the second stage moderator to introduce a sample opposite the target, the sample positioned to receive a flux of thermal neutrons from the target; and
a gamma ray detector located at one or more ends of the tube to detect gamma rays emitted by the sample.

25. The neutron source of claim 24, further comprising a thermal neutron shield substantially enclosing the neutron source, wherein the thermal neutron shield does not cover the one or more tube ends.

26. The neutron source of claim 25, wherein a thickness of the second moderator and a thickness of the thermal neutron shield to increase an amount of thermal neutron flux at the sample while reducing an amount of fast neutrons that may be received at the at least one gamma ray detector.

27. the method of claim 14 further comprising:
providing a tube through the second stage moderator for introducing a sample;
positioning the sample to receive an amount of neutron flux from the target; and
detecting an amount of gamma rays emitted from the sample by a gamma ray detector positioned at one or more ends of the tube.

28. The method of claim 27, further comprising forming a thermal neutron shield to substantially enclose the neutron source, wherein the thermal neutron shield does not cover the one or more tube ends.

29. the method of claim 28, further comprising selecting a thickness of the second moderator and a thickness of the thermal neutron shield to increase an amount of thermal neutron flux at the sample while reducing an amount of last neutrons that may be received at the at least one gamma ray detector.
